(19) United States
(12) Patent Application Publication
(10) Pub. No.: US 2019/0113800 A1
(43) Pub. Date: Apr. 18, 2019

(54) Color Filter Substrate and Method for Manufacturing the Same, Display Panel and Display Device

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventor: Guangying MOU, Beijing (CN)

(21) Appl. No.: 16/050,272

(22) Filed: Jul. 31, 2018

(30) Foreign Application Priority Data
Oct. 18, 2017 (CN) 201710971109.3

(51) Int. Cl. G02F 1/1335

(52) U.S. Cl. CPC G02F 1/133516; G02F 2001/133357; G02F 1/133512

(57) ABSTRACT

The present disclosure provides a color filter substrate and a method for manufacturing the same, a display panel and a display device. The method includes: forming black matrix above a base substrate, the black matrix including light blocking lines intersected with each other; forming first planarization layer above the base substrate, the first planarization layer being filled between adjacent light blocking lines; forming a color filter layer above the first planarization layer and the black matrix, an orthographic projection of the color filter layer on the base substrate covering that of the first planarization layer on the base substrate and partially covering the orthographic projection of the black matrix on the base substrate; forming a second planarization layer above the color filter layer, an orthographic projection of the second planarization layer on the base substrate covering those of the black matrix and the color filter layer on the base substrate.

### CROSS-REFERENCE TO RELATED APPLICATION

The present application claims priority to Chinese Patent Application No. 201710971109.3 filed on Oct. 18, 2017, the disclosure of which is hereby incorporated by reference.

### TECHNICAL FIELD

The present disclosure relates to the field of display technology, and in particular, to a method for manufacturing a color filter substrate, a color filter substrate, a display panel and a display device.

### BACKGROUND

The color filter substrate is an important component in a TFT-LCD (Thin Film Transistor Liquid Crystal Display) panel for filtering backlight (white light) to form primary colors of red (R), green (G), and blue (B). OC (Organic Coating) is a transparent coating coated on R/G/B color filters for planarizing surfaces of the R/G/B color filters in the color filter substrate.

### SUMMARY

An embodiment of the present disclosure provides a method for manufacturing a color filter substrate, including: forming a black matrix above a base substrate, wherein the black matrix includes a plurality of light blocking lines intersected with each other; forming a first planarization layer above the base substrate on which the black matrix has been formed, wherein the first planarization layer is filled between adjacent light blocking lines of the black matrix; forming a color filter layer above the first planarization layer and the black matrix, an orthographic projection of the color filter layer on the base substrate covering an orthographic projection of the first planarization layer between adjacent light blocking lines of the black matrix on the base substrate and partially covering an orthographic projection of the black matrix on the base substrate; and forming a second planarization layer above the color filter layer, an orthographic projection of the second planarization layer on the base substrate covering the orthographic projections of the black matrix and the color filter layer on the base substrate.

In some implementations, the step of forming the first planarization layer includes: coating a layer of photosensitive material above the base substrate and the black matrix; exposing the photosensitive material between the adjacent light blocking lines of the black matrix; removing the photosensitive material in an unexposed area such that the photosensitive material in an exposed area forms the first planarization layer.

In some implementations, the photosensitive material is a transparent photopolymerizable organic material.

In some implementations, the step of forming the first planarization layer includes: coating a layer of low viscosity material above the base substrate and the black matrix; performing a curing treatment on the low viscosity material, so that the first planarization layer is formed, by the low viscosity material, between the adjacent light blocking lines of the black matrix and on a surface of the black matrix.

In some implementations, a thickness of the first planarization layer between the adjacent light blocking lines of the black matrix is greater than that of the first planarization layer on the base surface of the black matrix.

In some implementations, the color filter layer comprises a red color filter, a green color filter and a blue color filter.

An embodiment of the present disclosure provides a color filter substrate including: a base substrate; a black matrix which is provided on the base substrate and includes a plurality of light blocking lines intersected with each other; a first planarization layer provided between adjacent light blocking lines of the black matrix; a color filter layer provided above the first planarization layer and the black matrix, wherein an orthographic projection of the color filter layer on the base substrate covering an orthographic projection of the first planarization layer between the adjacent light blocking lines of the black matrix on the base substrate and partially covering the orthographic projection of the black matrix on the base substrate; a second planarization layer provided above the black matrix and the color filter layer, wherein an orthographic projection of the second planarization layer on the base substrate covering the orthographic projections of the black matrix and the color filter layer on the base substrate.

In some implementations, the first planarization layer is formed of a transparent photopolymerizable organic material.

In some implementations, the first planarization layer further covers a surface of the black matrix.

In some implementations, the first planarization layer is formed of a low viscosity material.

In some implementations, a thickness of the first planarization layer between the adjacent light blocking lines of the black matrix is greater than a thickness of the first planarization layer on the base surface of the black matrix.

In some implementations, the color filter layer comprises a red color filter, a green color filter and a blue color filter.

An embodiment of the present disclosure provides a display panel including the above color filter substrate.

An embodiment of the present disclosure provides a display device including the above display panel.

### BRIEF DESCRIPTION OF THE DRAWINGS

FIG. 1 is a flow chart showing steps of a method for manufacturing a color filter substrate in an embodiment of the present disclosure;

FIG. 2 is a schematic structural diagram of a base substrate on which a black matrix has been formed in an embodiment of the present disclosure;

FIG. 3 is a schematic structural diagram of a base substrate coated with a layer of photosensitive material in an embodiment of the present disclosure;

FIG. 4 is a schematic structural diagram of a base substrate subjected to an exposure processing in an embodiment of the present disclosure;

FIG. 5 is a schematic structural diagram showing a base substrate on which a first planarization layer has been formed in an embodiment of the present disclosure;

FIG. 6 is a schematic structural diagram showing a structure on which a layer of low viscosity material has been coated in an embodiment of the present disclosure;

FIG. 7 is one schematic structural diagram showing a base substrate on which a color filter layer has been formed in an embodiment of the present disclosure;

FIG. 8 is another schematic structural diagram of a base substrate on which a color filter layer has been formed in an embodiment of the present disclosure;

FIG. 9 is a schematic structural diagram of a color filter substrate in an embodiment of the present disclosure;

FIG. 10 is another schematic structural diagram of a color filter substrate in an embodiment of the present disclosure

### DETAILED DESCRIPTION

Embodiments of the present disclosure will be described in detail below with reference to the accompanying drawings. It should be understood that the embodiments described herein are only used to explain and illustrate the present disclosure, but not to limit the present disclosure.

In some implementations, in a manufacturing process of color filter substrates, due to process and design constraints, horn-shaped protrusions are generally formed at positions where the BM (Black Matrix) and RGB filters overlap, and OC coating cannot achieve completely planarization. The “horn-shaped step difference” formed at junctions of RGB filters and BM affects the uniformity of the alignment film in the rubbing process. This is because the “horn-shaped step difference” causes different rubbing at a high position and a low position caused by the horn, so that a ununiform-alignment area occurs between the high and low positions, and the ununiform-alignment area is likely to cause light leakage.

An embodiment of the present disclosure provides a method for manufacturing a color filter substrate.

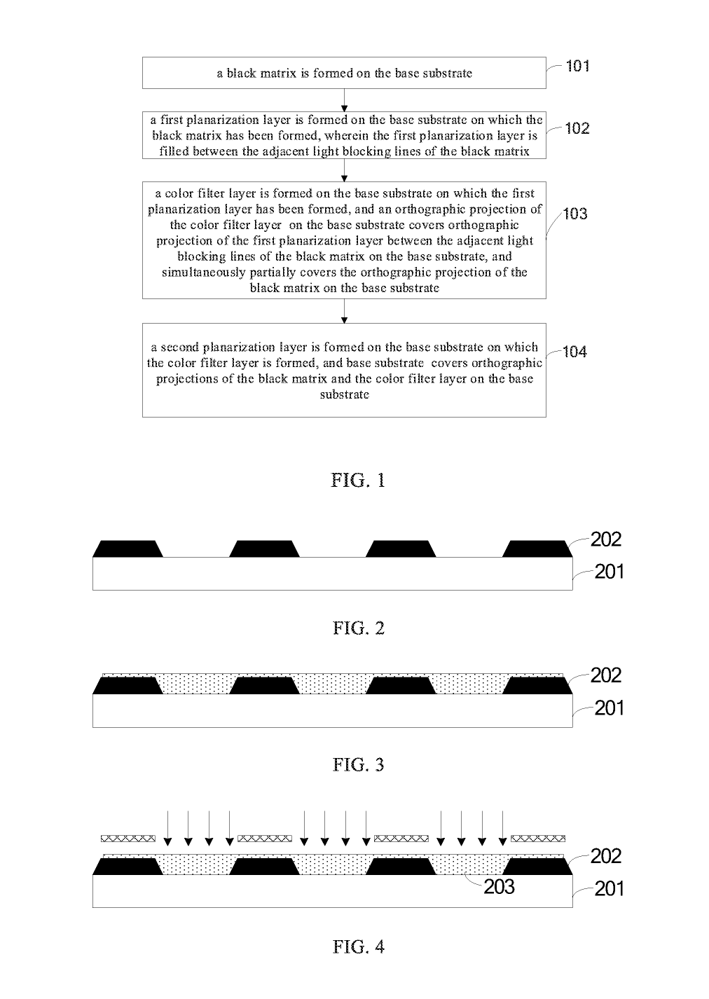

FIG. 1 is a flow chart showing the steps of the method for manufacturing a color filter substrate in an embodiment of the present disclosure. As shown in FIG. 1, the method includes the following steps 101-104.

At step 101, a black matrix is formed on a base substrate.

In this embodiment, a the black matrix 202 including a plurality light blocking lines intersected with each other is formed on the base substrate 201, and a partportions of the base substrate is are exposed between adjacent light blocking lines of the black matrix 202, and the base substrate on which the black matrix has been formed is as shown in FIG. 1. The base substrate may be a glass substrate or made of other materials, which is not limited in the embodiments of the present disclosure in detail and may be selected according to actual conditions.

At step 102, a first planarization layer is formed on the base substrate on which the black matrix has been formed, wherein the first planarization layer is filled between the adjacent light blocking lines of the black matrix 202.

In the present embodiment, the first planarization layer 203 is formed on the base substrate 201 on which the black matrix 202 has been formed, wherein the first planarization layer 203 is filled between the adjacent light blocking lines of the black matrix 202. In an implementation, the first planarization layer 203 may be formed by the following sub-steps 1-3.

Sub-step 1, a layer of photosensitive material is coated on the base substrate 201 and the black matrix 202, and the base substrate coated with the photosensitive material is as shown in FIG. 3. For example, the photosensitive material is a transparent photopolymerizable organic material. The components of the photopolymerizable organic material may include an epoxy resin, an acrylate, a photoinitiator, a thermal initiator, a surfactant and the like, which is not limited in the embodiments of the present disclosure, and may be set according to actual conditions.

Sub-step 2, an exposure process is performed on the photosensitive material between the adjacent light blocking lines of the black matrix 202, as shown in FIG. 4, the photosensitive material composed of the photopolymerizable organic material is cured by a polymerization effect under the action of light. The lithographic mask for manufacturing the black matrix 202 can be used for performing the exposure process on the photosensitive material between the adjacent light blocking lines of the black matrix 202, which is not limited in the embodiments of the present disclosure, and may be set according to actual conditions.

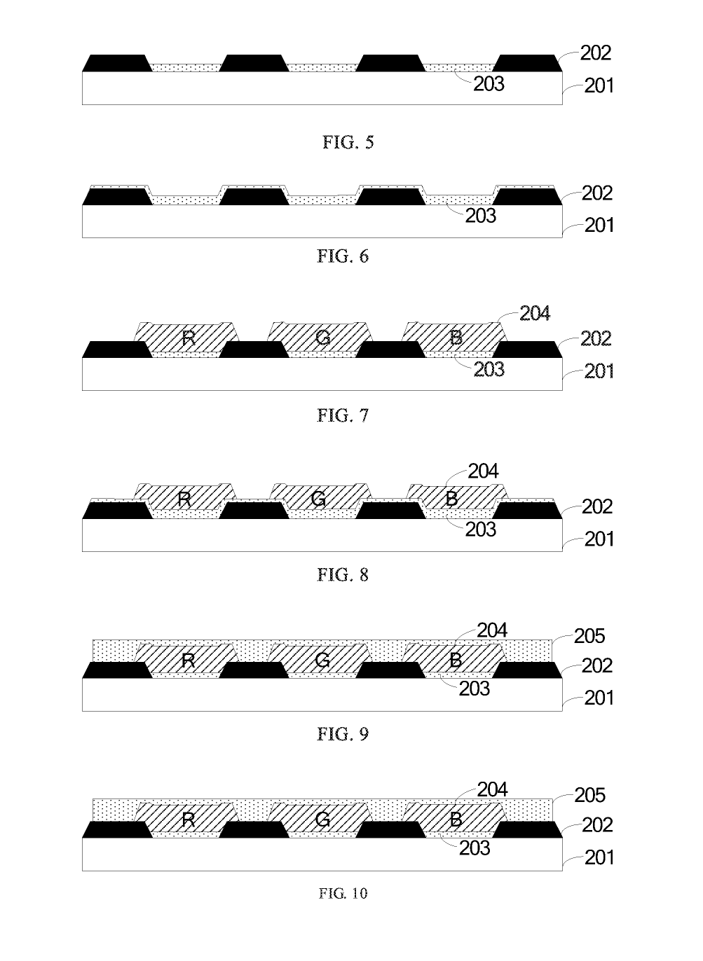

Sub-step 3, the photosensitive material in the unexposed area is removed, so that the photosensitive material in the exposed area forms the first planarization layer 203, as shown in FIG. 5.

In an implementation, the first planarization layer 203 may also be formed by the following sub-steps 4-5.

Sub-step 4, coating a layer of low viscosity material on the base substrate 201 and the black matrix 202, the low viscosity material covering the base substrate 201 and the black matrix 202 is as shown in FIG. 6. The low viscosity material can be made on the basis of the OC material by reducing the molecular weight of the epoxy resin, the acrylate therein, or increasing the proportion of the solvent therein, which is not limited in the embodiments of the present disclosure and may be set according to actual conditions.

Sub-step 5, performing a curing treatment on the low viscosity material, the low viscosity material forming the first planarization layer 203 between the adjacent light blocking lines of the black matrix 202 and on the surface of the black matrix 202. A thickness of the first planarization layer 203 between adjacent light blocking lines of the black matrix 202 is greater than a thickness of the first planarization layer 203 on the surface of the black matrix 202. As shown in FIG. 6, the low viscosity material has a low viscosity and a good fluidity, so the thickness of the first planarization layer 203 in the recess region between the adjacent light blocking lines of the black matrix 202 is larger than the thickness of the first planarization layer 203 on the surface of the black matrix 202. The curing treatment may be performed by photocuring or by heat curing, which is not limited in detail in the embodiments of the present disclosure and may be set according to actual conditions.

Step 103, a color filter layer 204 is formed on the base substrate 201 on which the first planarization layer 203 has been formed, and an orthographic projection of the color filter layer 204 on the base substrate 201 covers the orthographic projection of the first planarization layer 203 between the adjacent light blocking lines of the black matrix 202 on the substrate 201, and simultaneously partially covers the orthographic projection of the black matrix 202 on the base substrate 201.

In this embodiment, the color filter layer 204 is formed on the first planarization layer 203 while a portion of the color filter layer 204 overlaps the black matrix 202, as shown in FIGS. 7 and 8, wherein the color filter layer 204 includes three color filters of R, G and B. Since the first planarization layer 203 is formed before the color filter layer 204 is formed, the color filter layer 204 can be raised, that is, the color filter layer 204 is not directly formed on the base substrate 201, thereby reducing the thickness of the color filter layer 204. The “horn-shaped step difference” formed at the positions where the color filter layer 204 overlaps with the black matrix 202 becomes small.

Step 104, a second planarization layer 205 is formed on the base substrate 201 on which the color filter layer 204 has been formed, and an orthographic projection of the second planarization layer 205 on the base substrate 201 covers orthographic projections of the black matrix 202 and the color filter layer 204 on the base substrate 201.

In the present embodiment, as shown in FIGS. 9 and 10, the second planarization layer 205 is formed to cover the black matrix 202 and the color filter layer 204. After the second planarization layer 205 is formed, the second planarization layer 205 may be planarized. The planarization process is not limited in detail in the embodiments of the present disclosure and may be set according to actual conditions.

In the present embodiment, a planarization layer which is generally formed as a single-layered structure by using a same material is formed as a two-layered structure including the first planarization layer and the second planarization layer. For example, when forming the first planarization layer, the amount of material used is ⅔ of the total amount of the material used for the complete planarization layer; and when the second planarization layer is formed, the amount of material used is ⅓ of the total amount of the material used for the complete planarization layer. In the color filter substrate thus formed, not only the raised height of the color filter layer by the first planarization layer can be ensured, but also the thickness of the second planarization layer covering on the surface of the base substrate can be ensured, thereby achieving a better planarization effect.

In summary, in the embodiment of the present disclosure, a black matrix is formed on the base substrate; a first planarization layer is formed, and the first planarization layer is filled between adjacent light blocking lines of the black matrix; a color filter layer is formed on the first planarization layer, and the orthographic projection of the color filter layer on the base substrate covers the orthographic projection of the first planarization layer between the adjacent light blocking lines of the black matrix on the base substrate while partially covering the orthographic projection of the black matrix on the base substrate, in this step, a “horn-shaped step difference” may be formed. However, since the planarization layer is formed under the color filter layer, the color filter layer is raised as a whole, which reduces the “horn-shaped step difference” at the position where the color filter layer and the black matrix overlap. Furthermore, the planarization layer are formed by two steps, improving the flatness, reducing or even avoiding ununiform-alignment area, thus solving the problem of light leakage when there is a misalignment in the display panel.

FIG. 9 illustrates a color filter substrate provided in an embodiment of the present disclosure, the color filter substrate includes: a base substrate 201; a black matrix 202 which is provided above the base substrate 201 and includes a plurality of light blocking lines intersected with each other; a first planarization layer 203 provided between adjacent light blocking lines of the black matrix; a color filter layer 204 provided above the first planarization layer 203 and the black matrix 202, wherein an orthographic projection of the color filter layer 204 on the base substrate 201 covering an orthographic projection of the first planarization layer 203 between adjacent light blocking lines of the black matrix on the base substrate and partially covering the orthographic projection of the black matrix on the base substrate 201; a second planarization layer 205 provided above the black matrix 202 and the color filter layer 204, wherein an orthographic projection of the second planarization layer 205 on the base substrate 201 covers orthographic projections of the black matrix 202 and the filter layer 204 on the base substrate 201.

In this embodiment, the black matrix 202 is formed on the base substrate 201, and the first planarization layer 203 is filled between the adjacent light blocking lines of the black matrix 202. The color filter layer 204 is formed on the first planarization layer 203, and a “horn shaped step difference” may be formed at the area where the color filter layer 204 covers the black matrix 202. However, since the first planarization layer 203 is formed under the color filter layer 204, the color filter layer 204 is raised, thereby lowering the height of the “horn-shaped step difference” and improving the flatness.

In an implementation, the first planarization layer 203 is a layer of transparent photopolymerizable organic material.

In an implementation, the first planarization layer 203 is also overlaid on the surface of the black matrix 202.

For example, in the present embodiment, as shown in FIG. 10, the first planarization layer 203 is filled between adjacent light blocking lines of the black matrix 202 while also covering the surface of the black matrix 202.

In an implementation, the first planarization layer 203 is formed of a low viscosity material, the thickness of the first planarization layer 203 between the adjacent light blocking lines of the black matrix 202 is greater than the thickness of the first planarization layer 203 on the surface of the black matrix 202.

In the present embodiment, the first planarization layer 203 is formed of the low viscosity material, the low viscosity material has a good fluidity, thus after coating the low viscosity material, the low viscosity material flowing into the recess area between the adjacent light blocking lines of the black matrix 202 is more than that covering the surface of the black matrix 202. Thus, the thickness of the first planarization layer 203 formed between adjacent light blocking lines of the black matrix 202 is greater than the thickness of the first planarization layer 203 on the surface of the black matrix 202.

In summary, in the embodiment of the present disclosure, the color filter substrate includes a base substrate and a black matrix formed on the base substrate, the black matrix includes a plurality of light blocking lines intersected with each other, and a first planarization layer is filled between adjacent light blocking lines of the black matrix, a color filter layer is provided on the first planarization layer, and a second planarization layer is provided on the black matrix and the color filter layer. The color filter layer and the black matrix overlap so that a “horn-shaped step difference” may be formed. However, since the first planarization layer is formed under the color filter layer, the color filter layer is raised as a whole, and the “horn-shaped step difference” is lowered. In the present disclosure, the planarization process is composed of the first planarization layer and the second planarization layer, the flatness is improved, and ununiform-alignment area is reduced or even avoided, thereby solving the problem that light leakage occurs when there is a misalignment in the display panel.

An embodiment of the present disclosure provides a display panel. The display panel includes the aforementioned color filter substrate. The color filter substrate includes: a base substrate 201; a black matrix 202, which is provided above the base substrate 201 and includes a plurality of light blocking lines intersected with each other; a first planarization layer 203 provided between adjacent light blocking lines of the black matrix 202; a color filter layer 204 provided above the first planarization layer 203 and the black matrix 202, wherein an orthographic projection of the color filter layer 204 on the base substrate 201 covering an orthographic projection of the first planarization layer 203 between adjacent light blocking lines of the black matrix 202 on the substrate 201 and partially covering the orthographic projection of the black matrix 202 on the base substrate 201; a second planarization layer 205 provided above the black matrix 202 and the color filter layer 204, wherein an orthographic projection of the second planarization layer 205 on the base substrate 201 covers orthographic projections of the black matrix 202 and the filter layer 204 on the base substrate 201.

In summary, in the embodiment of the present disclosure, the display panel includes a color filter substrate including a substrate, a black matrix, a first planarization layer, a color filter layer, and a second planarization layer. The color filter substrate of the display panel of the present disclosure includes a planarization layer composed of a first planarization layer and a second planarization layer, wherein the first planarization layer is formed under the color filter layer, and the color filter layer is raised as a whole, and the “horn-shaped step difference” formed at positions where the color filter layer and the black matrix overlap is reduced. The flatness is improved, and the ununiform-alignment area is reduced or even avoided, thereby solving the problem of light leakage when there is a misalignment in the display panel.

Am embodiment of the present disclosure provides a display device. The display device includes the aforementioned display panel, and the display panel includes the aforementioned color filter substrate. The color filter substrate includes: a base substrate 201; a black matrix 202, which is provided above the base substrate 201 and includes a plurality of light blocking lines intersected with each other; a first planarization layer 203 provided between adjacent light blocking lines of the black matrix 202; a color filter layer 204 provided above the first planarization layer 203 and the black matrix 202, wherein an orthographic projection of the color filter layer 204 on the base substrate 201 covering an orthographic projection of the first planarization layer 203 between adjacent light blocking lines of the black matrix 202 on the base substrate 201 and partially covering the orthographic projection of the black matrix 202 on the base substrate 201; a second planarization layer 205 provided above the black matrix 202 and the color filter layer 204, wherein an orthographic projection of the second planarization layer 205 on the base substrate 201 covers orthographic projections of the black matrix 202 and the filter layer 204 on the base substrate 201.

In summary, in the embodiment of the present disclosure, the display device includes a color filter substrate including a base substrate, a black matrix, a first planarization layer, a color filter layer, and a second planarization layer. The color filter substrate of the display device of the present disclosure includes a planarization layer composed of a first planarization layer and a second planarization layer, wherein the first planarization layer is formed under the color filter layer, and the color filter layer is raised as a whole, and the “horn-shaped step difference” formed at positions where the color filter layer and the black matrix overlap is reduced. The flatness is improved, and the ununiform-alignment area is reduced or even avoided, thereby solving the problem of light leakage when there is a misalignment in the display panel.

The various embodiments in the present specification are described in a progressive manner, and each embodiment focuses on differences from other embodiments, and the same or similar parts among the various embodiments can be referred to each other.

Finally, it should be noted that, in this context, relational terms such as first and second are merely used to distinguish one entity or operation from another entity or operation, and do not necessarily require or imply that any such actual relationship or order exists between these entities or operations. Furthermore, the terms “comprise”, “include” or any other variations thereof are intended to cover non-exclusive inclusion, such that a process, method, product, or equipment including a series of elements includes not only these elements, but also other elements not being definitely listed, or further includes elements inherent to such process, method, product or equipment. Without additional limitations, element that is defined by the phrase “comprising/including a . . . ” does not exclude the presence of additional elements in the process, method, product, or equipment which includes the element.

It should be understood that, the foregoing embodiments are only exemplary embodiments used for explaining the principle of the present disclosure, but the present disclosure is not limited thereto. Various variations and improvements may be made by a person skilled in the art without departing from the spirit and essence of the present disclosure, and these variations and improvements also fall into the protection scope of the present disclosure.

1. A method for manufacturing a color filter substrate, comprising steps of:
forming a black matrix above a base substrate, wherein the black matrix comprising a plurality of light blocking lines intersected with each other;
forming a first planarization layer above the base substrate on which the black matrix has been formed, wherein the first planarization layer is filled between adjacent light blocking lines of the black matrix;
forming a color filter layer above the first planarization layer and the black matrix, an orthographic projection of the color filter layer on the base substrate covering an orthographic projection of the first planarization layer between adjacent light blocking lines of the black matrix on the base substrate and partially covering the orthographic projection of the black matrix on the base substrate; and
forming a second planarization layer above the color filter layer, wherein an orthographic projection of the second planarization layer on the base substrate covering the orthographic projections of the black matrix and the color filter layer on the base substrate.

2. The method of claim 1, wherein the step of forming the first planarization layer comprises:
coating a layer of photosensitive material above the base substrate and the black matrix;
exposing the photosensitive material between the adjacent light blocking lines of the black matrix; and
removing photosensitive material in an unexposed area such that the photosensitive material in an exposed area forms the first planarization layer.

3. The method of claim 2, wherein the photosensitive material is a transparent photopolymerizable organic material.

4. The method of claim 1, wherein the step of forming the first planarization layer comprises:
coating a layer of low viscosity material above the base substrate and the black matrix;
performing a curing treatment on the low viscosity material, so that the first planarization layer is formed, by the low viscosity material, between the adjacent light blocking lines of the black matrix and on a surface of the black matrix.

5. The method of claim 4, wherein a thickness of the first planarization layer between the adjacent light blocking lines of the black matrix is greater than that of the first planarization layer on the surface of the black matrix.

6. The method of claim 1, wherein the color filter layer comprises a red color filter, a green color filter and a blue color filter.

7. A color filter substrate, comprising:
a base substrate;
a black matrix which is provided on the base substrate and comprises a plurality of light blocking lines intersected with each other;
a first planarization layer provided between adjacent light blocking lines of the black matrix;
a color filter layer provided above the first planarization layer and the black matrix, wherein an orthographic projection of the color filter layer on the base substrate covering an orthographic projection of the first planarization layer between adjacent light blocking lines of the black matrix on the base substrate and partially covering the orthographic projection of the black matrix on the base substrate;
a second planarization layer provided above the black matrix and the color filter layer, wherein an orthographic projection of the second planarization layer on the base substrate covering the orthographic projections of the black matrix and the color filter layer on the base substrate.

8. The color filter substrate of claim 7, wherein the first planarization layer is a layer of transparent photopolymerizable organic material.

9. The color filter substrate of claim 7, wherein the first planarization layer further covers a surface of the black matrix.

10. The color filter substrate of claim 9, wherein the first planarization layer is formed of a low viscosity material.

11. The color filter substrate of claim 9, wherein a thickness of the first planarization layer between the adjacent light blocking lines of the black matrix is greater than a thickness of the first planarization layer on the surface of the black matrix.

12. The color filter substrate of claim 7, wherein the color filter layer comprises a red color filter, a green color filter and a blue color filter.

13. A display panel comprising the color filter substrate of claim 7.

14. A display panel comprising the color filter substrate of claim 8.

15. A display panel comprising the color filter substrate of claim 9.

16. A display panel comprising the color filter substrate of claim 10.

17. A display device comprising the display panel of claim 13.

18. A display device comprising the display panel of claim 14.

19. A display device comprising the display panel of claim 15.

20. A display device comprising the display panel of claim 16.
